(19) United States
(12) Patent Application Publication
(10) Pub. No.: US 2013/0103265 A1
(43) Pub. Date: Apr. 25, 2013

(54) VEHICLE GRILLE SHUTTER

(71) Applicants: John C. Remy, Shelby Township, MI (US); David J. Verbrugge, Milford, MI (US); Louis D. Thole, Grosse Pointe Park, MI (US); Scott P. Charnesky, Birmingham, MI (US)

(72) Inventors: John C. Remy, Shelby Township, MI (US); David J. Verbrugge, Milford, MI (US); Louis D. Thole, Grosse Pointe Park, MI (US); Scott P. Charnesky, Birmingham, MI (US)

(73) Assignee: GM GLOBAL TECHNOLOGY OPERATIONS LLC, Detroit, MI (US)

(21) Appl. No.: 13/280,389

(22) Filed: Oct. 25, 2011

(51) Int. Cl. B60K 11/08

(52) U.S. Cl. 701/49

(57) ABSTRACT

A method of acknowledging a presence of an individual relative to a vehicle having a grille opening includes detecting that the vehicle is stationary. The method also includes sensing the presence of the individual relative to the vehicle. The method additionally includes setting an adjustable shutter in motion in response to the sensed presence of the individual when the vehicle is stationary. The shutter is arranged relative to the grille opening and is operable to selectively open and close the grille opening to present an appearance of a “wink”. A system using a controller configured to regulate the shutter and perform such a method is also provided.

### TECHNICAL FIELD

The invention relates to a system and a method of controlling a grille shutter in a vehicle.

### BACKGROUND

A shutter is typically a solid and stable covering for an opening. A shutter frequently consists of a frame and louvers or slats mounted within the frame.

Louvers may be fixed, i.e., having a permanently set angle with respect to the frame. Louvers may also be operable, i.e., having an angle that is adjustable with respect to the frame for permitting a desired amount of light, air, and/or liquid to pass from one side of the shutter to the other. Depending on the application and the construction of the frame, shutters can be mounted to fit within, or to overlap the opening. In addition to various functional purposes, particularly in architecture, shutters may also be employed for largely ornamental reasons.

In motor vehicles, a shutter may be employed to control and direct a stream of air to various vehicle compartments and/or subsystems. Particularly, a shutter may be positioned at the front of the vehicle and employed to cool a vehicle's powertrain, as well as enhance comfort of vehicle passengers.

### SUMMARY

A method of acknowledging a presence of an individual relative to a vehicle having a grille opening includes detecting that the vehicle is stationary. The method also includes sensing the presence of the individual relative to the vehicle. The method additionally includes setting an adjustable shutter in motion in response to the sensed presence of the individual when the vehicle is stationary. The shutter is arranged relative to the grille opening and is operable to selectively open and close the grille opening to present an appearance of a “wink”.

The vehicle may include a controller configured to regulate operation of the shutter, and wherein each of the acts of detecting that the vehicle is stationary, sensing the presence of the individual, and setting the adjustable shutter in motion is accomplished via the controller.

The method may also include transmitting a signal via a device and receiving the signal via the controller such that the presence of the individual is sensed when the device is present on the individual.

The vehicle may include a powerplant configured to be selectively turned on and off. In such a case, the powerplant being turned off may be employed as an indicator that the vehicle is stationary. Additionally, the speed of the vehicle being zero may be employed as an indicator that the vehicle is stationary.

The shutter may include a mechanism regulated by the controller and configured to adjust the shutter to selectively open and close the grille opening.

The method may additionally include detecting whether the shutter is being obstructed and regulating the mechanism to cease setting the shutter in motion if the shutter is being obstructed.

The mechanism may include a motor configured to apply a motor torque to adjust the shutter and a torque sensor configured to sense the motor torque. Furthermore, the motor torque may exceed a predetermined maximum torque value when the shutter is being obstructed. The method may additionally include reducing the motor torque via the controller when the motor torque exceeds the predetermined maximum torque value to thereby cease setting the shutter in motion.

The vehicle may include a grille mesh arranged between the shutter and the compartment such that the grille mesh restricts entry of debris from the ambient into the compartment.

The shutter may be inset in the grille opening such that the shutter is the leading feature in the grille opening relative to the ambient.

A system used to perform such a method is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic view of a system for acknowledging a presence of an individual relative to a vehicle having a shutter depicted in a fully closed state, wherein a partial side cross-sectional view of the vehicle is shown;

FIG. 2 is a schematic view of the system and a partial side cross-sectional view of the vehicle having the shutter shown in FIG. 1, with the shutter depicted in an intermediate state;

FIG. 3 is a schematic view of the system and a partial side cross-sectional view of the vehicle having the shutter shown in FIGS. 1 and 2, with the shutter depicted in a fully opened state; and

FIG. 4 is a flow chart illustrating a method of acknowledging a presence of an individual relative to the vehicle depicted in FIGS. 1-3.

### DETAILED DESCRIPTION

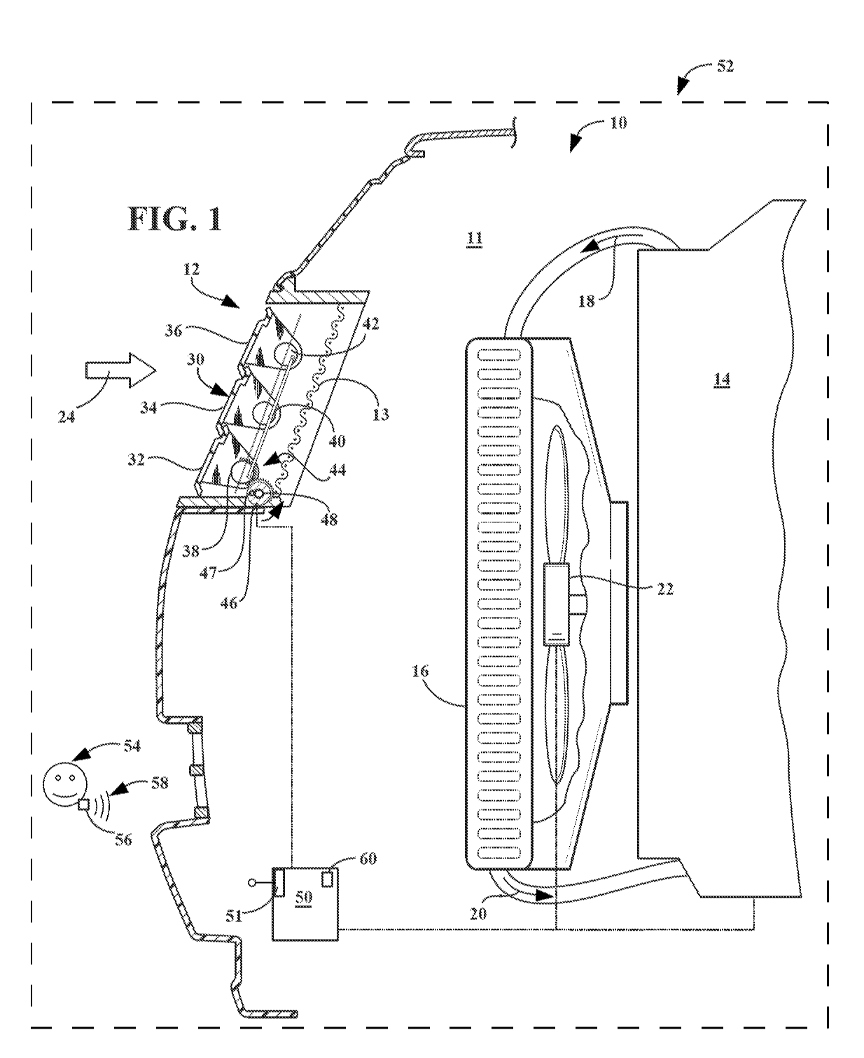

Referring to the drawings, wherein like reference numbers refer to like components, FIGS. 1-3 show a partial side view of a vehicle 10. The vehicle 10 includes a compartment 11. The vehicle 10 is additionally shown to include a grille opening 12 that is covered by a grille mesh 13. The grille opening 12 is adapted for receiving ambient air and admitting such air to the compartment 11, while the grille mesh 13 is configured to restrict entry of debris from the ambient into the compartment. The compartment 11 is configured to house a powertrain. The powertrain includes a powerplant, which is specifically represented by an internal combustion engine 14. Generally, internal combustion engines may be configured to be selectively turned on for powering the vehicle and turned off when the vehicle is stationary or to conserve fuel. The powertrain of the vehicle 10 may additionally include a transmission, and, if the vehicle is a hybrid type, one or more motor-generators, none of which is shown, but the existence of which can be appreciated by those skilled in the art. Efficiency of a vehicle powertrain is generally influenced by its design, as well as by the various loads the powertrain sees during its operation.

The vehicle 10 additionally includes an air-to-fluid heat exchanger 16, i.e., a radiator, for circulating a cooling fluid shown by arrows 18 and 20, such as water or a specially formulated coolant, through the engine 14 to remove heat from the engine. A high-temperature coolant entering the heat exchanger 16 is represented by the arrow 18, and a reduced-temperature coolant being returned to the engine is represented by the arrow 20. The heat exchanger 16 is positioned behind the grille opening 12 for protection of the heat exchanger from various road-, and air-borne debris. The heat exchanger 16 may also be positioned in any other location, such as behind a passenger compartment, if, for example, the vehicle has a rear or a mid-engine configuration, as understood by those skilled in the art.

As shown in FIGS. 1-3, a fan 22 is positioned in the vehicle 10, behind the heat exchanger 16, such that the heat exchanger 16 is positioned between the grille opening 12 and the fan. The fan 22 is capable of being selectively turned on and off based on the cooling needs of the engine 14. Depending on the road speed of the vehicle 10, the fan 22 is adapted to either generate or enhance a flow of ambient air or airflow 24 through the grille opening 12, and toward and through the heat exchanger 16. Thus generated or enhanced through the action of the fan 22, the airflow 24 is passed through the heat exchanger 16 to remove heat from the high-temperature coolant 18 before the reduced-temperature coolant 20 is returned to the engine 14.

FIGS. 1-3 also depict a rotatable or adjustable shutter 30. The shutter 30 is inset and secured in the grille opening 12 such that the shutter is the leading feature in the grille opening relative to the ambient airflow 24. Accordingly, the grille mesh 13 is arranged between the shutter 30 and the compartment 11. The shutter 30 is configured to regulate an amount of the airflow 24 entering or flowing into the vehicle through the grille opening 12. The shutter 30 may also be incorporated into and be integral with the grille opening 12. The shutter 30 includes a plurality of louvers, herein shown as having three individual louver elements 32, 34, and 36, but the number of louvers may either be fewer or greater.

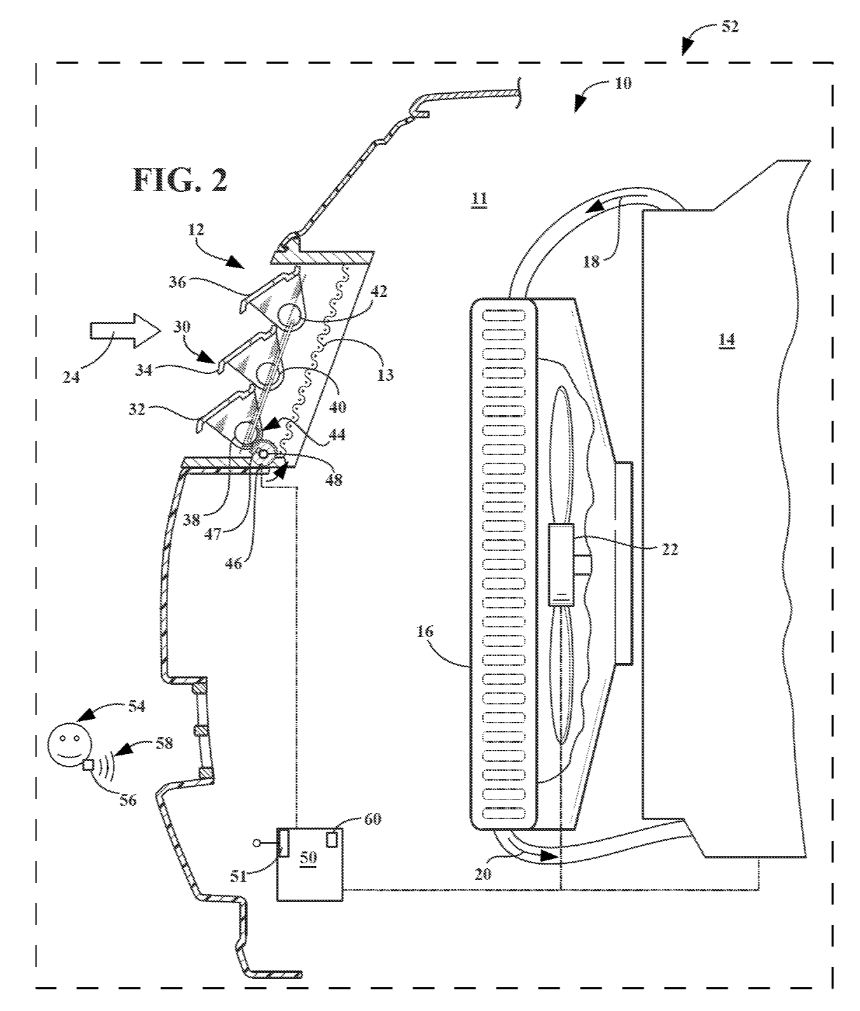

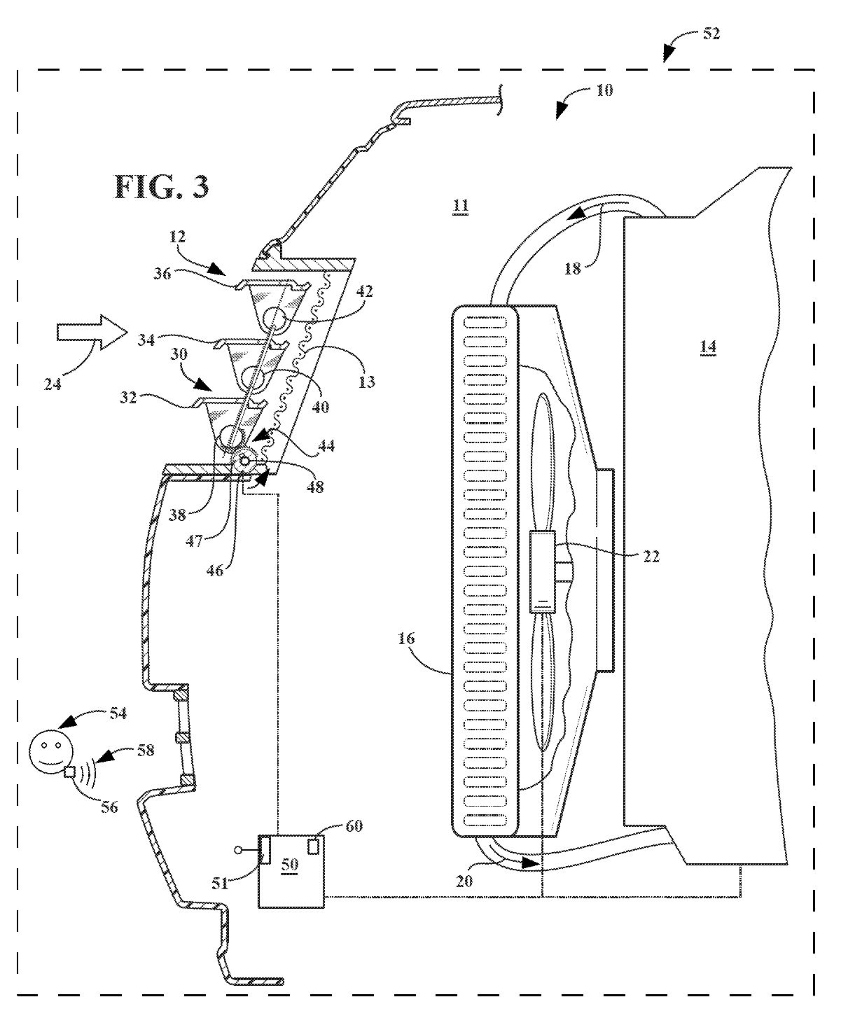

Each louver 32, 34, and 36 is configured to rotate about a respective pivot axis 38, 40, and 42 during operation of the shutter 30, thereby effectively controlling the size of the grille opening 12 and the amount of ambient air flowing into the vehicle. The shutter 30 is adapted to operate between and inclusive of a fully-closed position or state (as shown in FIG. 1), through an intermediate or partially-closed position (as shown in FIG. 2), and to a fully-opened position (as shown in FIG. 3). When the louver elements 32, 34, and 36 are in any of their open positions, the airflow 24 enters the vehicle 10 by penetrating the plane of shutter 30 before coming into contact with the heat exchanger 16.

The shutter 30 also includes a mechanism 44 configured to adjust the shutter, and thereby select and lock a desired position of the shutter between and inclusive of fully-opened and fully-closed. The mechanism 44 is configured to cause the louvers 32-36 to rotate in tandem, i.e., substantially in unison, and permitting the shutter 30 to rotate into any of the available positions. The mechanism 44 may be adapted to select and lock either discrete intermediate position(s) of the louvers 32-36, or to infinitely vary position of the louvers between and inclusive of the fully-opened and fully-closed. The mechanism 44 acts to select the desired position for the shutter 30 and may include an electric motor 46 configured to apply motor torque to adjust the position of the shutter. The mechanism 44 may also include a sensor 47, shown as a strain gage positioned on the motor shaft 48 and configured to sense the motor torque.

The vehicle 10 also includes a controller 50, which may be an engine controller or a separate control unit, configured to operate the mechanism 44 via the motor 46 for selecting the desired position of the shutter 30. The controller 50 may also be configured to operate the fan 22, if the fan is electrically driven, and a thermostat (not shown) that is configured to regulate the circulation of coolant, as understood by those skilled in the art. The controller 46 is programmed to operate the mechanism 44 according to the load on the engine 14 when the engine 14 is turned on and generating heat. Additionally, the controller 46 is programmed to operate the mechanism 44 when the vehicle 10 is stationary and the engine 14 is turned off.

When the shutter 30 is fully-closed, as depicted in FIG. 1, the louvers 32-36 provide blockage of the airflow 24 at the grille opening 12. When the vehicle 10 is in motion, but when engine cooling through the grille opening 12 is not required, a fully-closed shutter 30 provides optimized aerodynamics for the vehicle 10. When the vehicle 10 is stationary and the engine 14 is turned off, the fully-closed position of the shutter 30 additionally provides a nearly seamless appearance by closing the grille opening. Such nearly seamless appearance of the closed grille opening 12 may be considered aesthetically pleasing and also prevent access of various ambient debris to the compartment 11 through the grille opening.

The shutter 30 may also be operated by the controller 50 to variably restrict access of the oncoming airflow 24 to the compartment 11, by rotating the louvers 32-36 to an intermediate position, as shown in FIG. 2, where the louvers are partially closed. An appropriate intermediate position of the louvers 32-36 may be selected by the controller 46 according to a programmed algorithm to thereby affect the desired cooling of the engine 14. The shutter 30 may also be placed in a fully-opened position, as shown in FIG. 3, wherein each louver 32-36 is rotated to a position parallel to the airflow 24 seeking to penetrate the shutter system plane. Thus, a fully-opened shutter 30 is configured to permit a generally unfettered passage of such a stream of air through the louver plane of the shutter 30.

As depicted in FIGS. 1-3, the vehicle 10 is included in a system 52. The system 52 is configured for acknowledging a presence of an individual 54 relative to the vehicle. The individual being referred herein may be an actual operator or user of the vehicle 10. As employed by the system 52, the controller 50 is additionally configured to detect that the vehicle 10 is stationary and sense the presence of the individual 54 relative to the vehicle. As illustrated in FIGS. 1-3, the system 52 further includes a device 56 that is configured to transmit a signal 58. The device 56 may be a transmitter that generates the requisite signal 58 and broadcasts the signal via radio waves on a specifically selected frequency. Accordingly, the controller 50 may include a receiver 51 configured to detect or receive the signal 58 such that when the device 56 is present on the individual 54 the presence of the individual near the vehicle is sensed.

The controller 50 is additionally configured to set the shutter 30 in motion in response to the sensed presence of the individual 54 when the vehicle 10 is stationary, such that the motion of the shutter presents an appearance of a “wink”. The appearance of a wink may be generated by the mechanism 44 rotating the louvers 32-36 anywhere between and inclusive of the fully-closed and the fully-opened positions described above in a relatively rapid manner. For example, in order to be perceived as a wink, the louvers 32-36 may be opened and closed within a timeframe of approximately 0.5 seconds. Such an appearance of a wink by the shutter 30 is intended to generate a visual acknowledgement of the particular individual 54 by the vehicle 10 when the individual arrives within a predetermined vicinity of the vehicle. Accordingly, the strength of the signal 58 may be established based on a particular distance between the device 56 and the controller 50 such that the shutter 30 may be in view of the individual 54. Furthermore, the controller 50 may be programmed to activate the shutter 30 in order to visually acknowledge that the particular individual 54 is exiting the effective receiving range of the receiver 51. Therefore, setting the shutter 30 in motion in such a case would be dependent on the effective distance between the device 56 and the receiver 51.

When the vehicle 10 is stationary, the progress of the subject vehicle relative to a road surface is zero. Accordingly, the speed of the vehicle 10 or movement of the vehicle's powertrain components, such as an output shaft of the transmission, may be detected by the controller 50 and be used as an indicator that the vehicle is stopped. Additionally, the controller 50 may detect when the engine 14 is turned off and employ the detection of such a state with or without the detected speed of the vehicle 10 as an indicator that the vehicle 10 is stationary. The controller 50 may also be configured to detect whether the shutter 30 is being obstructed by debris, an animal, or another individual. In the situation that the controller 50 detects the shutter 30 being obstructed, the controller may proceed to regulate the mechanism 44 to cease setting the shutter in motion. Such ceasing of setting the shutter 30 in motion may be carried out to prevent failure of the mechanism 44 and/or to avoid injury to any animal or individual that may otherwise become pinched by the louvers 32-36.

To cease setting the shutter 30 in motion when the shutter is being obstructed, the controller 50 may control the motor 46 to reduce the motor torque when such torque exceeds a predetermined maximum torque value 60. The motor torque may be sensed by the sensor 47, as described above, and the sensed motor torque may then be communicated to the controller 50. The predetermined maximum torque value 60 may be indicative of the motor torque that is sufficiently below a threshold level of discomfort for an animal or an individual, if such is caught between the louvers 32-36, as well as being sufficiently below the structural durability limit of the shutter 30 and the mechanism 44. Accordingly, the predetermined maximum torque value 60 may be programmed into the controller 50 and be used as a reference for comparison to the sensed motor torque during operation of the shutter 30.

Ambient temperatures near and below freezing may present considerations activating the system 52. When the ambient temperature is below a predetermined value, i.e., near or below freezing, the louvers 32-36 and the mechanism 44 may freeze and become jammed. Therefore, in order to prevent failure of the shutter 30 and jamming thereof in some unwanted position, when the ambient temperature is below the predetermined value the system 12 may be deactivated by sensing the motor torque via the sensor 47.

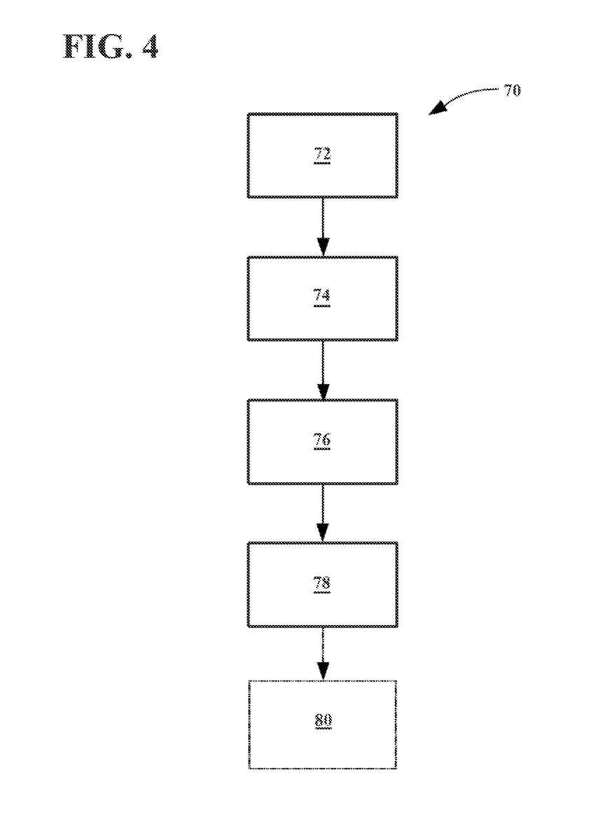

FIG. 4 depicts a method 70 of acknowledging a presence of the individual 54 relative to the vehicle 10, as described above with respect to FIGS. 1-3. The method commences in frame 72 and then proceeds to frame 74 where it includes detecting that the vehicle 10 is stationary. In frame 74, the controller 50 may be responsible for performing the detection of the vehicle state. Following frame 74, the method advances to frame 76. In frame 76, the method includes sensing the presence of the individual 54 relative to the vehicle 10. As described with respect to FIGS. 1-3 above, in frame 76 the sensing the presence of the individual 54 may be accomplished via the device 56 that generates the signal 58 to the controller 50.

Following frame 76, the method proceeds to frame 78. In frame 78, the method includes setting the shutter 30 in motion in response to the sensed presence of the individual 54 when the vehicle 10 is stationary by selectively opening and closing the louvers 32-36 to present an appearance of a “wink”. From frame 78, the method may additionally advance to frame 80, where the method includes detecting whether the shutter 30 is being obstructed. In frame 80, the method may also include regulating the mechanism 44 to cease setting the shutter 30 in motion if the shutter is being obstructed.

While the best modes for carrying out the invention have been described in detail, those familiar with the art to which this invention relates will recognize various alternative designs and embodiments for practicing the invention within the scope of the appended claims.

1. A method of acknowledging a presence of an individual relative to a vehicle having a grille opening, the method comprising:
detecting that the vehicle is stationary;
sensing the presence of the individual relative to the vehicle; and
setting an adjustable shutter in motion in response to the sensed presence of the individual when the vehicle is stationary;
wherein the shutter is arranged relative to the grille opening and is operable to selectively open and close the grille opening to present an appearance of a “wink”.

2. The method of claim 1, wherein the vehicle includes a controller configured to regulate operation of the shutter, and wherein each of said detecting that the vehicle is stationary, sensing the presence of the individual, and setting the adjustable shutter in motion is accomplished via the controller.

3. The method of claim 2, further comprising transmitting a signal via a device and receiving the signal via the controller such that the presence of the individual is sensed when the device is present on the individual.

4. The method of claim 2, wherein the vehicle includes a powerplant configured to be selectively turned on and off, and the powerplant being turned off is an indicator that the vehicle is stationary.

5. The method of claim 2, wherein the speed of the vehicle being zero is an indicator that the vehicle is stationary.

6. The method of claim 2, wherein the shutter includes a mechanism regulated by the controller, the method further configured for adjusting the shutter using the mechanism to selectively open and close the grille opening.

7. The method of claim 6, further comprising detecting whether the shutter is being obstructed and regulating the mechanism to cease setting the shutter in motion if the shutter is being obstructed.

8. The method of claim 7, wherein the mechanism includes a motor configured to apply a motor torque to adjust the shutter and a torque sensor configured to sense the motor torque, and the motor torque exceeds a predetermined maximum torque value when the shutter is being obstructed, the method further comprising reducing the motor torque via the controller when the motor torque exceeds the predetermined maximum torque value to thereby cease setting the shutter in motion.

9. The method of claim 1, wherein the vehicle includes a grille mesh arranged between the shutter and the compartment, such that the grille mesh is configured to restrict entry of debris from the ambient into the compartment.

10. The method of claim 1, wherein the shutter is inset in the grille opening and is the leading feature in the grille opening relative to the ambient.

11. A system for acknowledging a presence of an individual relative to a vehicle having a grille opening, the system comprising:
an adjustable shutter arranged relative to the grille opening and operable to selectively open and close the grille opening; and
a controller configured to:
detect that the vehicle is stationary;
sense the presence of the individual relative to the vehicle; and
set the shutter in motion in response to the sensed presence of the individual when the vehicle is stationary to thereby present an appearance of a “wink”.

12. The system of claim 11, further comprising a device configured to transmit a signal, wherein the controller is configured to receive the signal such that the presence of the individual is sensed when the device is present on the individual.

13. The system of claim 11, wherein the vehicle includes a powerplant configured to be selectively turned on and off, and the powerplant being turned off is an indicator that the vehicle is stationary.

14. The system of claim 11, wherein the speed of the vehicle being zero is an indicator that the vehicle is stationary.

15. The system of claim 11, wherein the shutter includes a mechanism regulated by the controller and configured to adjust the shutter to selectively open and close the grille opening.

16. The system of claim 15, wherein the controller is additionally configured to detect whether the shutter is being obstructed and regulate the mechanism to cease setting the shutter in motion if the shutter is being obstructed.

17. The system of claim 16, wherein:
the mechanism includes a motor configured to apply a motor torque to adjust the shutter;
a torque sensor configured to sense the motor torque;
the motor torque exceeds a predetermined maximum torque value when the shutter is being obstructed; and
the controller is additionally configured to reduce the motor torque when the motor torque exceeds the predetermined maximum torque value to thereby cease setting the shutter in motion.

18. The system of claim 11, wherein the vehicle includes a grille mesh arranged between the shutter and the compartment, such that the grille mesh is configured to restrict entry of debris from the ambient into the compartment.

19. The system of claim 11, wherein the shutter is inset in the grille opening and is the leading feature in the grille opening relative to the ambient.

20. A system for acknowledging a presence of an individual relative to a vehicle having a grille opening, the system comprising:
an adjustable shutter arranged relative to the grille opening and operable to selectively open and close the grille opening;
a device configured to transmit a signal; and
a controller configured to:
detect that the vehicle is stationary;
sense the presence of the individual relative to the vehicle;
receive the signal such that the presence of the individual is sensed when the device is present on the individual;
set the shutter in motion in response to the sensed presence of the individual when the vehicle is stationary to thereby present an appearance of a “wink”;
detect whether the shutter is being obstructed; and
regulate the mechanism to cease setting the shutter in motion if the shutter is being obstructed.
